(19) United States
(12) Patent Application Publication
(10) Pub. No.: US 2017/0063645 A1
(43) Pub. Date: Mar. 2, 2017

(54) Method, Computer Program and Node for Management of Resources

(71) Applicant: TELEFONAKTIEBOLAGET LM ERICSSON (PUBL), Stockholm (SE)

(72) Inventors: Patrizia Testa, Solna (SE); Joacim Halén, Sollentuna (SE)

(21) Appl. No.: 15/120,147

(22) PCT Filed: Feb. 25, 2014
(86) PCT No.: PCT/SE2014/050228

§ 371 Date: Aug. 19, 2016

(51) Int. Cl. H04L 12/24; G06N 99/00; G06N 5/02

(52) U.S. Cl. CPC H04L 41/5019; G06N 5/022; G06N 99/005; H04L 41/5009; H04L 41/5035

(57) ABSTRACT

A method, computer program and an SLA management node (100) in a computer environment (50) for monitoring and managing of resources (110) for an application (120), the method comprises determining (S100) an SLA metric for an SLA (Service Level Agreement), determining (S110) at least one dependent metric for the SLA metric, which indicates a resource (110) performance for the application (120), evaluating (S120) the at least one dependent metric's influence on the SLA metric, determining (S130) a weight for the at least one dependent metric, based on the dependent metric influence of the SLA metric, for prediction of the dependent metric influence of the SLA metric.

### TECHNICAL FIELD

The present disclosure relates generally to a method, node and computer program in a computer environment for monitoring and managing of resources for an application.

### BACKGROUND

Management of computer environments is becoming more complex from one perspective due to the increasing system sizes. From another perspective it is becoming easier through automation. However, an automated system only works as well as it is created. I.e. the automated systems performance relies on the underlying technology for the automation. Another aspect related to management of computer environments, is the fact that it is becoming more common to share hardware platforms among applications. It is further becoming more common to separate computer hardware and applications by virtualizing the hardware. Such solutions may be described as shared environments, clouds, computer clouds, virtual environments, computer centers, hosting environments, or similar.

A shared environment may be created in different ways. An example of a structure is an application operating on an operating system, with the operating system running on a virtual machine. As compared to a single standalone solution, the virtual machine may replace the physical hardware seen from the application or operating system perspective. A number of virtual machines may be operated on the same physical hardware. Virtual machines serving the same type of application may be relocated or parallelized between different physical hardwares depending on the applications needs or characteristics, such as availability, performance or capacity.

The virtual machine may be controlled by a hypervisor, where the hypervisor locally may manage the virtual machine on the physical hardware. The hypervisor may for example in a controlled way provide or allocate resources for the virtual machine such as bandwidth, CPU power (Central Processing Unit), memory capacity, or storage capacity. A single physical machine including all its software may sometimes be denoted a host.

On a higher level the hypervisor may be controlled by a resource manager or a cloud manager. The resource manager may control and instruct the hypervisor. The resource manager may for example have control over which applications that should be operated on which host, prioritization, start and stop of hosts.

There are obvious benefits with shared environments, such as the possibility of a plurality of applications sharing the same hardware, sharing functions such as databases, antivirus protection, firewalls, etc., which may be costly to maintain. Not at least to mention a descent physical environment with shell protection, cooling and constant electricity supply.

In order to operate computer environments, including shared environments as well as computers for a particular purpose, the computer environment needs to be properly managed.

In some cases a computer environment is serving according to a particular agreed level, such agreed level may be termed service level agreement (SLA). The SLA may be an agreed level of technical performance, minimum bandwidth, minimum CPU capacity, maximum system delay, as a few examples of parameters. An SLA may be applied on different levels. A high level example may be provision of a telephony service or an IP TV service (Internet Protocol Television). A lower level example may be provision of storage capacity or CPU instructions per second.

Regardless of the level of the SLA, in order to determine that the SLA is not violated, proper measurements are required and potentially actions taken following the measurements. Sometimes may the terms “metric” or “parameter” be used to describe what to measure. That is a metric may be a parameter for monitoring of an SLA, such that the SLA is fulfilled. There may be a number of metrics determining how to monitor an SLA. On the other side, it may not only be a question of monitoring metrics and maintain them below certain levels. In order for a service provider, or an operator of a computer environment, the resources should be well utilized. Otherwise, the provider or operator may be carrying unjustifiable costs for the computer environment.

However, there are problems with the existing solutions for shared environments, clouds and similar computer center solutions. One problem is an increasing energy need with the growing shared environments, because both the computers themselves as well as the cooling for them require substantial energy supply. Another problem is to gather adequate information about how to set up and manage applications running in a shared environment, depending on SLA's (Service Level Agreement) and resource demands. The structure in a shared environment may be complex and difficult to review.

### SUMMARY

It is an object of the invention to address at least some of the problems and issues outlined above. It is possible to achieve these objects and others by using a method, computer program and a node as defined in the attached independent claims.

According to one aspect, a method performed by an SLA management node in a computer environment is provided for monitoring and managing of resources for an application. The method comprises determining an SLA metric for an SLA (Service Level Agreement). The method comprises determining at least one dependent metric for the SLA metric, which indicates a resource performance for the application, evaluating the at least one dependent metric's influence on the SLA metric. The method comprises determining a weight for the at least one dependent metric, based on the dependent metric influence of the SLA metric, for prediction of the dependent metric influence of the SLA metric.

An advantage with the solution is that it enables prediction of a suitable change of resource allocation for an application.

According to another aspect, an SLA management node in a computer environment is provided for monitoring and managing of resources for an application. The node comprises processing means adapted to determine an SLA metric for an SLA (Service Level Agreement). The node comprises processing means adapted to determine at least one dependent metric for the SLA metric, which indicates a resource performance for the application. The node comprises processing means adapted to evaluate the at least one dependent metric's influence on the SLA metric. The node comprises processing means adapted to determine a weight for the at least one dependent metric, based on the dependent metric influence of the SLA metric, for prediction of the dependent metric influence of the SLA metric.

An advantage with the solution may be fewer alarms to handle for an operator.

According to another aspect, an SLA management node in a computer environment is provided for monitoring and managing of resources for an application. The SLA management node comprises a determination unit for determining an SLA metric for an SLA (Service Level Agreement). The SLA management node comprises the determination unit for determining at least one dependent metric for the SLA metric, which indicates a resource performance for the application. The SLA management node comprises an evaluation unit for evaluating the at least one dependent metric's influence on the SLA metric. The SLA management node comprises the determination unit for determining a weight for the at least one dependent metric, based on the dependent metric influence of the SLA metric, for prediction of the dependent metric influence of the SLA metric.

The above method and apparatus may be configured and implemented according to different optional embodiments. In one possible embodiment, the solution may comprise evaluating a statistical status for the SLA metric, wherein the statistical status may be determined as above or below at least one threshold. In one possible embodiment, the solution may comprise evaluating a dependency status for the SLA metric. In one possible embodiment, the solution may comprise that the dependency status may be evaluated through a weighted function of the at least one dependent metric status, wherein the dependency status may be determined as above or below at least one threshold.

In one possible embodiment, the solution may comprise that the statistical status and the dependency status of the SLA metric may be compared, wherein when the comparison indicates that the two statuses are different, an updated status of the SLA metric may be performed based on a worse value of the statistical status and the dependency status, wherein the status may be stored in a data storage. In one possible embodiment, the solution may comprise, when the statistical status and the dependency status are similar, that a current status of the SLA metric may be updated, wherein the status may be stored in the data storage. In one possible embodiment, the solution may comprise, when a status of an SLA metric or a dependent metric is changed, that a message may be transmitted to a corrective action handler, the message containing an instruction to change a resource allocation expected to influence the dependent metric.

In one possible embodiment, the solution may comprise, when a dependency metric, or the resource allocation effecting the dependency metric is changed, that the impact of the change may be evaluated with the impact of the SLA metric in comparison with an expected impact based on the weighted dependency metric, wherein any deviation between the impact of the change and the expected impact may be stored in a knowledge database. In one possible embodiment, the solution may comprise that a subsequent instruction to change the resource allocation, which may instruct to adopt the size of the resource allocation, based on the previous evaluation of the impact of the SLA metric. In one possible embodiment, the solution may comprise that SLA metrics and/or dependent metrics may be acquired through a monitoring API (Application Programming Interface). In one possible embodiment, the solution may comprise that the monitoring API may specify a metrics dependency of another metric.

In one possible embodiment, the solution may comprise evaluating a statistical status for the dependent metric, wherein the statistical status may be determined as above or below at least one threshold. In one possible embodiment, the solution may comprise evaluating a dependency status for the dependent metric. In one possible embodiment, the solution may comprise the dependency status which may be evaluated through a weighted function of the at least one dependent metric status, wherein the dependency status may be determined as above or below at least one threshold. In one possible embodiment, the solution may comprise the statistical status and the dependency status of the dependent metric may be compared, wherein when the comparison indicates that the two statuses are different, an updated status of the dependent metric may be performed based on a worse value of the statistical status and the dependency status, wherein the status may be stored in the data storage. In one possible embodiment, the solution may comprise when the statistical status and the dependency status are similar, a current status of the dependent metric may be updated, wherein the status may be stored in the data storage.

An advantage with the solution may be self-learning of a suitable size of a resource change for a desired effect of an applications SLA.

An advantage with the solution may be adaptation of resource management following new workload behavior of an application.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a block diagram illustrating the solution.

FIG. 2 is a flow chart illustrating a procedure in a SLA management node.

FIG. 3 is a flow chart illustrating a procedure in a SLA management node, according to some possible embodiments.

FIG. 4 is a flow chart illustrating a procedure in a SLA management node, according to further possible embodiments.

FIG. 5 is a block diagram illustrating some possible embodiments of the solution.

FIG. 6 is a block diagram illustrating some further possible embodiments of the solution.

FIG. 7 is a block diagram illustrating embodiments of the SLA management node.

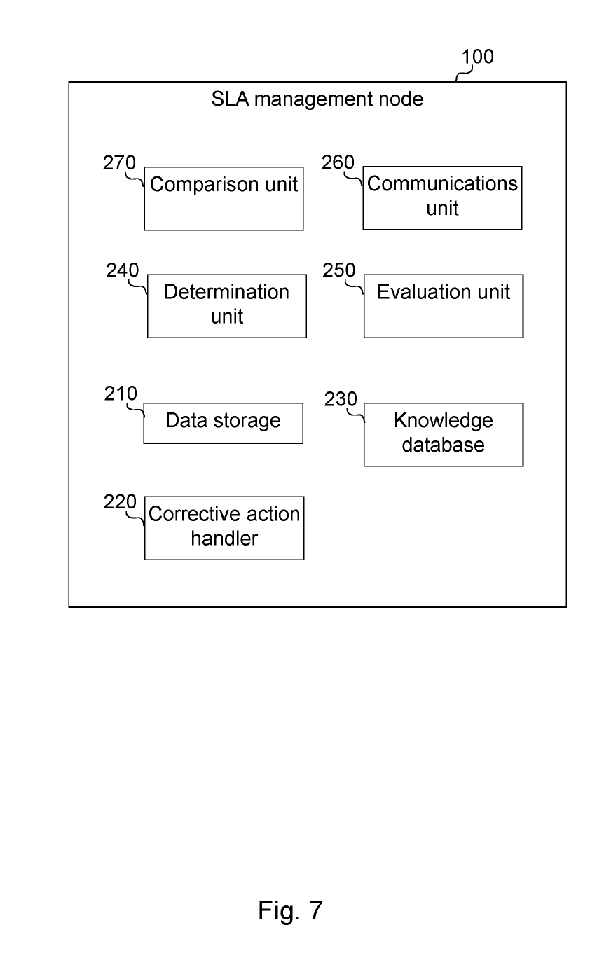

FIG. 8 is a block diagram illustrating some further embodiments of the SLA management node.

FIG. 9 is an overview of the solution according to further embodiments.

FIG. 10 is a block diagram illustrating some yet further embodiments of the SLA management node.

### DETAILED DESCRIPTION

Briefly described, a solution is provided to manage computer environments. Computer environments may be complex setups of both hardware as well as software components, depending on each other. Applications operated in a computer environment may be affecting each other, when being loaded or utilized. Different resources for an application may as well be affecting each other. In a complex environment it may be a challenging task for an operator to have an overview of how applications and resources are related and inter related. The task may be further challenging when applications or resources are affecting each other. Another factor which may be affecting the management of a computer environment, may be the fact that utilization of resources is not always linear in relation to the load.

The described solution provides a way of managing resources by determination of a metric for an SLA for an application and evaluation of the metrics influence of the SLA. The metric is provided a weight, which is intended to correspond to the metrics influence of the SLA. By evaluation of metrics influence, e.g. when a resource allocation is changed for an application, it may be possible to learn and predict a resource influence for fulfillment of the SLA. Through this procedure, it may be possible to predict application and resource behavior in a computer environment, without necessarily following all relations. It may further be possible to predict non-linear characteristics of applications or resources in a computer environment. Computer environment may also be termed communications network, shared environment, cloud, computer cloud or other terms with similar meaning. The term “metric” is used throughout the description, the term parameter may however also be used alternatively or complementary.

Service Level Agreement (SLA) automation in a computer environment may be important to support critical and real time applications and/or services. Some issues to address may be related to the difficulties to map SLA and infrastructure performance metrics to low level resource metrics in a deterministic way, being the computer infrastructure which may be a shared and rapidly changing environment.

The solution describes some options to allow specifying and monitoring the dependencies of the SLA metrics on metrics collected across the computer environment and automatically identifies potential sources of SLA violations and adapts corrective actions.

An SLA may consist of a set of parameters, each reflecting a measurable aspect or characteristic, such as availability, throughput, etc., of a service, operation or component, which needs to fulfill an agreed SLO (Service Level Object). An SLO may specify an SLA parameter threshold or permitted range in a given period. For each SLA parameter a set of metrics, observable parameters used to compute it, may be specified.

The solution may add intelligence to a monitoring service by specifying, at the API level (Application Programming Interface), for each collected metrics their direct dependencies on other metrics.

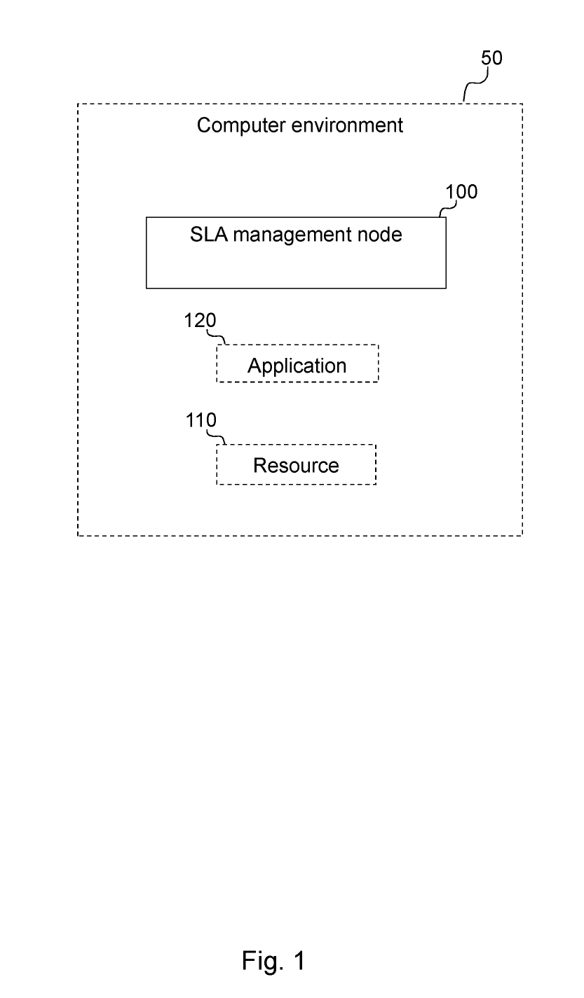

Below, the solution will be described in more detail. FIG. 1 illustrates an overview of the solution with a computer environment 50, an SLA management node 100 (Service Level Agreement) for management of SLA's, an application 120 and a resource 110 which may be managed properly for fulfillment of an SLA for the application 120.

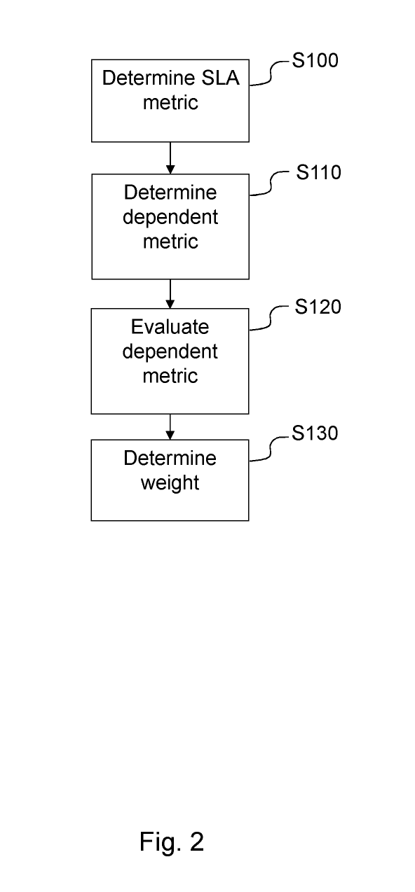

In an embodiment of the solution, illustrated by the flowchart in FIG. 2, a method is performed by an SLA management node 100 in a computer environment 50 for monitoring and managing of resources 110 for an application 120. The method comprises determination S100 of an SLA metric for an SLA. The method comprises determination S110 of at least one dependent metric for the SLA metric, which indicates a resource 110 performance for the application 120. The method comprises evaluation S120 of the at least one dependent metric's influence on the SLA metric. The method comprises determination S130 of a weight for the at least one dependent metric, based on the dependent metric influence of the SLA metric, for prediction of the dependent metric influence of the SLA metric.

The SLA management node 100 may be monitoring and managing the performance of a single application 120 or a group of applications 120. The application 120 may be operated according to an SLA, for example which operational requirements the application 120 should perform according to. A couple of non-limiting examples may be: If the application is a telephony switching application, it should be capable of switching 500 calls per second, each call should be switched within 100 milliseconds (ms). If the application 120 is a storage service, it should respond to log-on requests within 150 ms, it should be capable of receive and store 5 GB/s (Gigabyte per second) and capable to receive and transmit 10 GB/s.

In order for an application 120 to perform according to an agreed SLA, a resource 110 may need to meet the demand from the application 120. There may be a group of resources 110 providing what might be needed for the application 120.

To monitor the performance of the application 120 and the fulfillment of its SLA, it may be needed to determine an SLA metric for the SLA, e.g. what parameter to measure for the application's 120 fulfillment of the SLA. The applications 120 performance depends on resources 110 provided for the application 120, i.e. the application 120 is dependent on one or more resources 110 provided for the application 120. To understand the performance of the application 120, at least one dependent metric may be evaluated for the SLA metric. The dependent metric may indicate the performance of the resource 110. By evaluation of the dependent metrics influence on the SLA metric, it may be possible to understand how the performance of a resource 110 influence or affect the performance of an application 120.

By evaluation of the dependent metrics influence of the SLA metric, it may be possible to determine a weight for the dependent metric. The weight may then indicate the resource's 110 performance influence on the applications 120 performance. Thereby it may be possible to predict future dependent metric influence on a SLA metric.

By evaluation of the dependent metrics influence of a given metric, it may be possible to determine a weight for the dependent metric. The weight may then indicate the resource's 110 performance influence on resource behavior. Thereby it may be possible to predict future dependent metric influence on a given metric. Thereby it may be enabled to define a hierarchical structure of the metric status updating. For example, when a status is updated the status of the metric depending on such status may be automatically updated.

It may be advantageous to be able to determine a weight for a dependent metric because it may than be possible to predict or determine how much resources 110 that should be added or removed for an application, in order to have desired effect on the application 120. Another advantage may be that it may be possible to predict or determine how many resources 110 which should be allocated or removed for an application, in order to achieve a certain impact on the application's 120 performance from an SLA perspective. The weight of a dependent metric may enable how to predict a size or a magnitude of a corrective action.

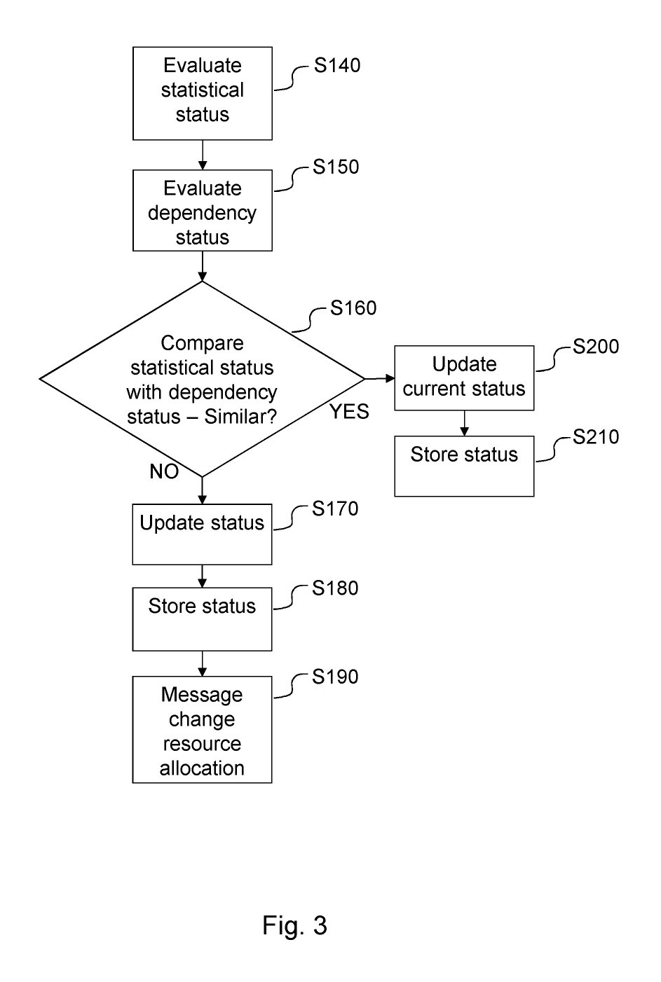

In an embodiment of the solution, for example illustrated in the flowchart shown in FIG. 3, a statistical status may be evaluated S140 for the SLA metric, wherein the statistical status may be determined as above or below at least one threshold. In an embodiment, there may be a plurality of thresholds, e.g. for different severity or different warning levels. A threshold may also be specified as an interval.

The statistical status may be a measured value of the SLA metric. When the SLA metric is based on a plurality of values, it may be a combination or a sum of the different values.

In an embodiment, a dependency status may be evaluated S150 for the SLA metric. The dependency status may be based on the dependent metric in combination with the weight of the dependent metric. In a case where there are pluralities of dependent metrics, the dependency status may be a result of the combined individual weighted dependent metrics.

In an embodiment, the dependency status may be evaluated through a weighted function of the at least one dependent metric status, wherein the dependency status may be determined as above or below at least one threshold. In an embodiment, there may be a plurality of thresholds, e.g. for different severity or different warning levels. A threshold may also be specified as an interval.

In an embodiment, the statistical status and the dependency status of the SLA metric may be compared S160, wherein when the comparison indicates that the two statuses are different, an updated status S170 of the SLA metric may be performed based on a worse value of the statistical status and the dependency status. The status may be stored S180 in a data storage (210).

This feature provides an aggregation of the status of an SLA metric. Any conclusion or action may be based on the worse of the results. Thereby will any conclusion or action for the status strive to ensure performance within an SLA. By storing the status in a data storage 210, it may be possible to learn about an application 120 and resource 110 behavior and correlation by understanding the relation between an SLA metric, a dependent metric and the weight for the dependent metric. The stored status may be used for updating of a status of dependent metric or dependent metrics.

In a situation where the SLA metric may be composed by a set of metrics, a plurality of dependent metrics may be influencing the SLA metric, it may be difficult to determine how the different dependent metrics will influence the SLA metric in different situations. By storing status data, it may be possible to learn and build experience, and thereby better provide weight for different dependent metrics. This in turn will enable better prediction of the application's 120 behavior in the computer environment 50.

In an embodiment, it may be a plurality of thresholds. An illustrating example may be, a status green, yellow, or red may be associated to each metric. It depends on the value of the relevant statistic with respect to specified thresholds and on the status of the metrics it depends on, each considered with a specified weight indicating the level of impact of each dependency.

An illustrating non-limiting example may be as follows. The status of a metric may be green if the relevant statistic is below a warning threshold W_T or if the sum of the weights of its dependencies with green status is above a given threshold T_green.

The status of a metric may be yellow if the relevant statistic is between the warning and maximum threshold or the sum of the weights of its dependencies in yellow status is above a given threshold T_yellow.

The status of a metric may be red if the relevant statistic value is above the maximum threshold or the sum of the weights of its dependencies in red status is above a given threshold T_red.

In an embodiment, when the statistical status and the dependency status are similar, a current status of the SLA metric may be updated S200, wherein the status is stored in a data storage 210. When the statistical status and the dependency are compared and found similar, the status may the same or similar as at a previous comparison. However, the statistical status and the dependency status may be similar at comparison, but the status value may have changed since the last comparison. By storing the status value, the status value may be basis for future understanding of a correct weight for the at least one dependent metric.

In an embodiment, when a status of an SLA metric or a dependent metric is changed, a message may be transmitted S190 to a corrective action handler 220. The message may contain an instruction to change a resource allocation expected to influence the dependent metric.

A change of the status of the SLA metric may be caused by an increased or decreased work load on the application 120. A change of the status of the dependent metric may be caused by increased work load of the application 120, but the status change of the dependent metric may also be due to a change in the surrounding environment, affecting the dependent metric.

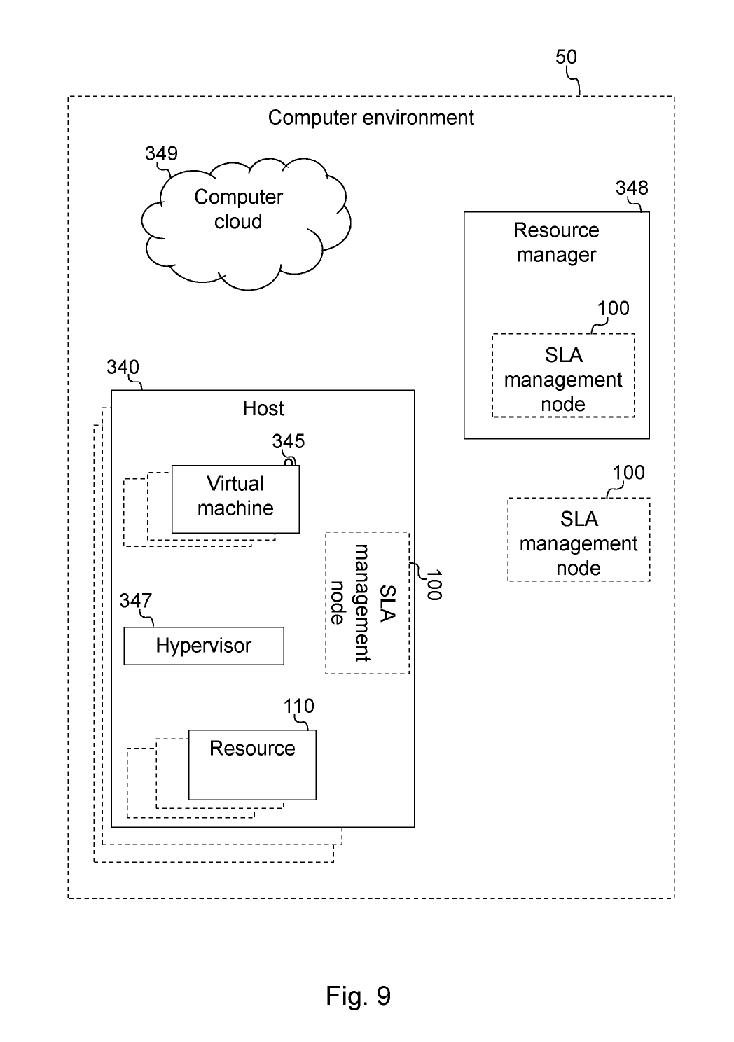

When a status is changed, a message may be transmitted to a correction handler 220. Depending if the status indicates a lack of resources 110 or a surplus of resources 110, the message may indicate that further resources 110 should be added or removed. Depending on the weight of a dependent metric and based on previous stored results, it may be possible to predict a suitable size of a change of resources 110. For example, a message may contain an instruction to add a single virtual machine 345. A virtual machine 345 is illustrated in FIG. 9. A message may contain an instruction to add a plurality of virtual machines 345. A message may contain an instruction to add a number of different types of resources 110, such as storage, processing, bandwidth, and encryption capacity.

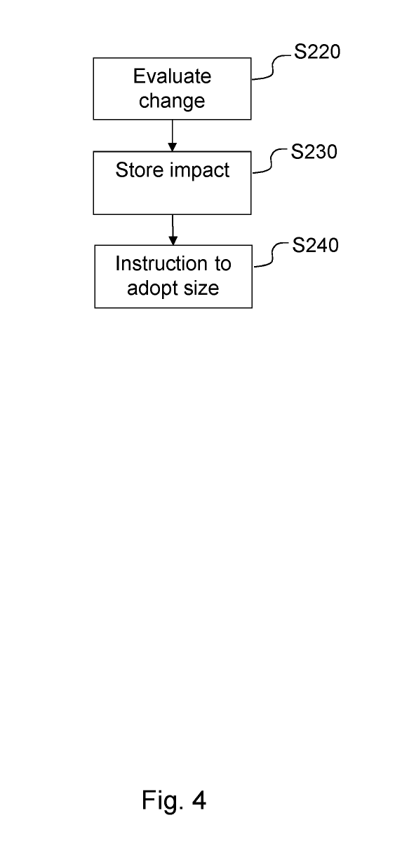

FIG. 4 illustrates a flowchart with embodiments of the solution, an embodiment may be when a dependency metric, or the resource allocation affecting the dependency metric is changed. The impact of the change may be evaluated S220 with the impact of the SLA metric in comparison with an expected impact based on the weighted dependency metric. Any deviation between the impact of the change and the expected impact may be stored S230 in a knowledge database 230. When the solution has been in operation for a time in a computer environment 50, an actual impact may be approximately corresponding with the expected impact. However, when the solution is newly operational in a computer environment 50, there may be a deviation or a difference, between a resulting impact of a change of the resource allocation and an expected impact. An advantage with this feature is that the solution may be gaining knowledge and build experience over time, i.e. the solution will learn and adopt changes of resource allocation for an optimal effect. Thereby may the solution learn to handle new types of applications 120, application behavior, or new type of application load, without or with limited need of manual work by an operator. In an embodiment, the solution may change resource allocation. In another embodiment, the solution may provide data as basis for a different system to perform the resource allocation. Examples of such other systems to perform resource allocation may be resource manager, cloud manager, hypervisor, and operating system.

In an embodiment, a subsequent instruction to change the resource allocation, may be instructing S240 to adopt the size of the resource allocation based on the previous evaluation of the impact of the SLA metric. When a deviation is indicated or when a deviation has been confirmed, between actual impact of a resource allocation and an expected resource allocation, the subsequent resource allocation may be adopted based on the previous impact. This may be applicable at identical application 120 user scenarios. This may also be applicable at similar application 120 scenarios. This may also be applicable at different application 120 scenarios.

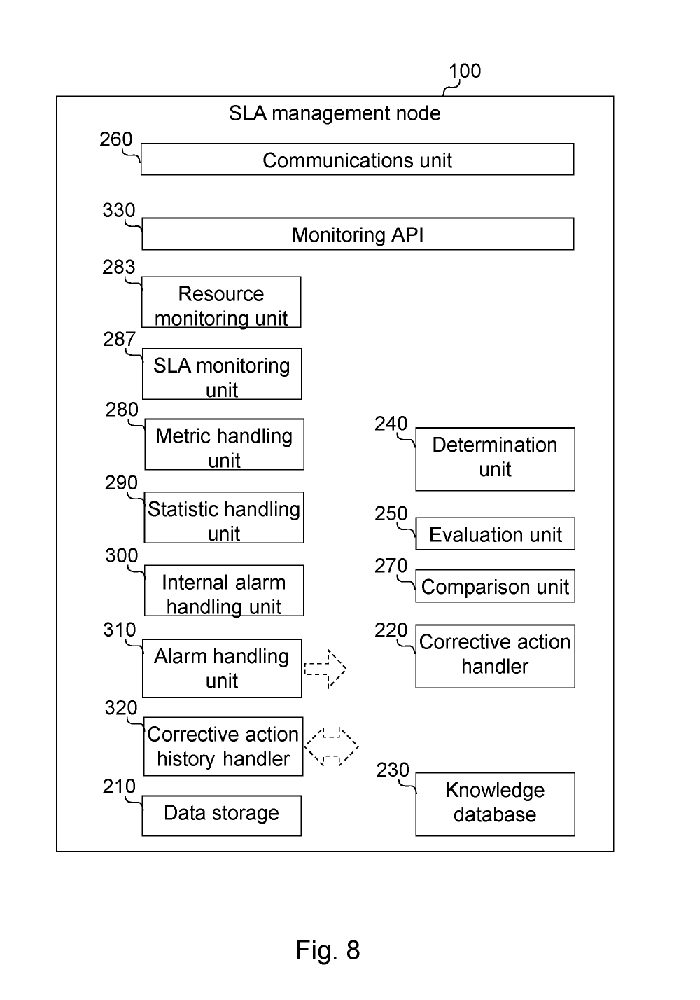

In an embodiment, SLA metrics and/or dependent metrics may be acquired through a monitoring API 330 (Application Programming Interface). The monitoring API 330 is further described in relation to FIG. 8 further below.

In an embodiment, the monitoring API 330 may specify a metrics dependency of another metric.

In an embodiment, a statistical status for the dependent metric may be evaluated. The statistical status may be determined as above or below at least one threshold.

In an embodiment, a dependency status for the dependent metric may be evaluated.

In an embodiment, the dependency status may be evaluated through a weighted function of the at least one dependent metric status. The dependency status may be determined as above or below at least one threshold.

In an embodiment, the statistical status and the dependency status of the dependent metric may be compared. The comparison may indicate that the two statuses are different, an updated status of the dependent metric may be performed based on a worse value of the statistical status and the dependency status. The status may be stored in the data storage 210.

In an embodiment, a current status of the dependent metric may be updated, when the statistical status and the dependency status are similar. The status may be stored in the data storage 210.

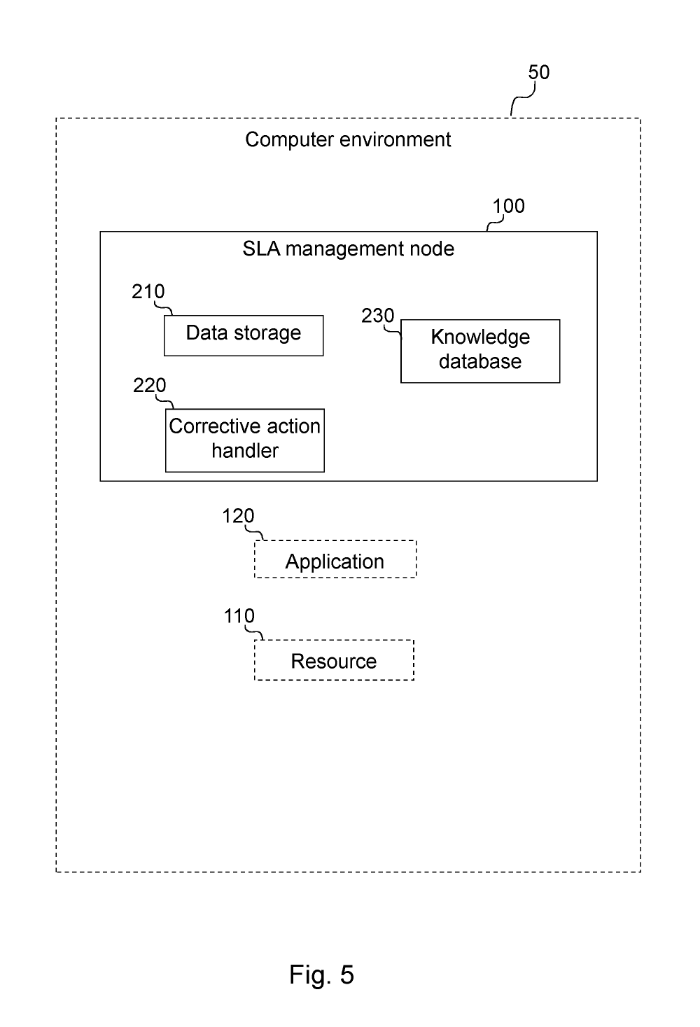

FIG. 5. illustrates an embodiment of the solution, with an SLA management node 100 in a computer environment 50 for monitoring and managing of resources 110 for an application 120. The node comprises processing means adapted to determine an SLA metric for an SLA (Service Level Agreement). The node comprises processing means adapted to determine at least one dependent metric for the SLA metric, which indicates a resource (110) performance for the application 120. The node comprises processing means adapted to evaluate the at least one dependent metric's influence on the SLA metric. The node comprises processing means adapted to determine a weight for the at least one dependent metric, based on the dependent metric influence of the SLA metric, for prediction of the dependent metric influence of the SLA metric.

In an embodiment, the SLA management node 100 may be adapted to evaluate a statistical status for the SLA metric, wherein the statistical status may be determined as above or below at least one threshold.

In an embodiment, the SLA management node 100 may be adapted to evaluate a dependency status for the SLA metric.

In an embodiment, the SLA management node may be adapted to evaluate the dependency status through a weighted function of the at least one dependent metric status, wherein the dependency status is determined as above or below at least one threshold.

In an embodiment, the SLA management node 100 may be adapted to compare the statistical status and the dependency status of the SLA metric, wherein when the comparison indicates that the two statuses are different, an updated status of the SLA metric may be performed based on a worse value of the statistical status and the dependency status, wherein the status may be stored in a data storage 210.

In an embodiment, the SLA management node may be adapted to, when the statistical status and the dependency status are similar, update a current status of the SLA metric, wherein the status may be stored in a data storage 210.

In an embodiment, the SLA management node 100 may be adapted to, when a status of an SLA metric or a dependent metric is changed, transmit a message to a corrective action handler 220, the message may contain an instruction to change a resource allocation expected to influence the dependent metric.

In an embodiment, the SLA management node 100 may be adapted to, when a dependency metric, or the resource allocation affecting the dependency metric, is changed, evaluate the impact of the change of the SLA metric in comparison with an expected impact based on the weighted dependency metric. Any deviation between the impact of the change and the expected impact may be stored in a knowledge database 230.

In an embodiment, a subsequent instruction to change the resource allocation, instructs to adopt the size of the resource allocation based on the previous evaluation of the impact of the SLA metric.

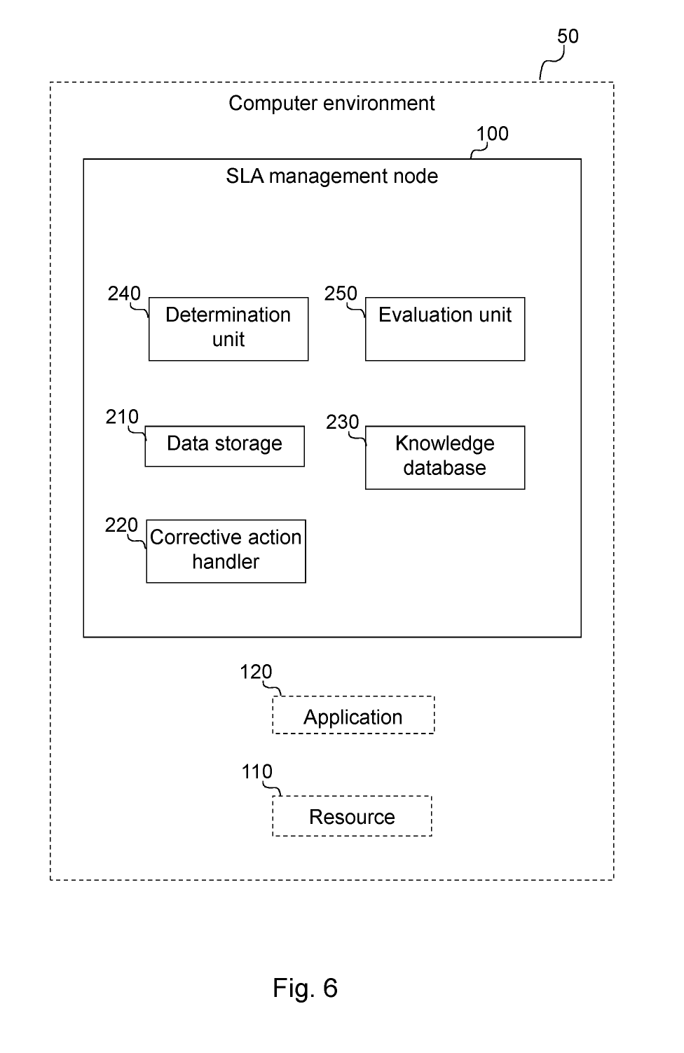

FIG. 6 illustrates an embodiment of the SLA management node 100 in a computer environment 50 for monitoring and managing of resources 110 for an application 120. The SLA management node comprises a determination unit 240 for determination of an SLA metric for an SLA (Service Level Agreement). The node comprises the determination unit 240 for determining at least one dependent metric for the SLA metric, which indicates a resource 110 performance for the application 120. The node comprises an evaluation unit 250 for evaluating the at least one dependent metric's influence on the SLA metric. The node comprises the determination unit 240 for determining a weight for the at least one dependent metric, based on the dependent metric influence of the SLA metric, for prediction of the dependent metric influence of the SLA metric.

In an embodiment, the SLA management node 100 may comprise the evaluation unit 250 for evaluation of a statistical status for the SLA metric. The statistical status may be determined as above or below at least one threshold.

In an embodiment, the SLA management node 100 may comprise the evaluation unit 250 for evaluation of a dependency status for the SLA metric.

In an embodiment, the SLA management node 100 may comprise the evaluation unit 250 for evaluation of the dependency status through a weighted function of the at least one dependent metric status. The dependency status may be determined as above or below at least one threshold.

In an embodiment, the SLA management node 100 may comprise a comparison unit 270 for comparison of the statistical status and the dependency status of the SLA metric. When the comparison indicates that the two statuses are different, an updated status of the SLA metric may be performed based on a worse value of the statistical status and the dependency status. The status may be stored in a data storage 210.

In an embodiment, the SLA management node 100 may update a current status of the SLA metric, when the statistical status and the dependency status are similar. The status may be stored in a data storage 210.

In an embodiment, the SLA management node 100 may comprise a communications unit 260 for transmission of a message to a corrective action handler 220 when a status of an SLA metric or a dependent metric may be changed. The message may contain an instruction to change a resource allocation expected to influence the dependent metric.

In an embodiment, the SLA management node 100 may comprise the evaluation unit 250 for evaluation of the impact of the change of the SLA metric in comparison with an expected impact based on the weighted dependency metric, when a dependency metric, or the resource allocation affecting the dependency metric may be changed. Any deviation between the impact of the change and the expected impact may be stored in a knowledge database 230.

In an embodiment, the SLA management node 100 may transmit a subsequent instruction to change the resource allocation, where the instruction may instruct to adopt the size of the resource allocation based on the previous evaluation of the impact of the SLA metric.

FIG. 8 illustrates an embodiment of the solution. This figure shows further details of the SLA management node 100, with optional functional units. The monitoring API 330 for monitoring of the computer environment 50. Through the monitoring API data related to SLA metrics as well as dependent metrics may be acquired. The communications unit 260 may handle communication between different optional units within the SLA management node 100, as well as with external entities. The communications unit 260 may handle communication with individual applications 120 and resources 110, other management functions for example in a host 340 (shown in FIG. 9) or a resource manager 350.

The metric handling unit 280 may handle metric data acquired through the monitoring API 330. The resource monitoring unit 283 may monitor resource performance, such as CPU utilization. The SLA monitoring unit 287 may monitor SLA metrics performance, such as end to end delay. The statistic handling unit 290 may collect, handle, and process statistics related to metric data. The internal alarm handling unit 310 may handle internal alarms related to status updates related to dependent metrics updates. The corrective action history handler 320 may handle history data related to corrections, i.e. at what circumstance was which action performed.

The corrective actions handler 220, determination unit 240, evaluations unit 250, and comparison unit 270 may operate as described in previous embodiments. The data storage 210 may be suitable for storage of for example metrics data, statistics, alarms, performed corrective actions, and similar type of data. The figure further shows the knowledge database 230 for storage of corrective actions and their related effect, and other knowledge data which increase the solutions capability to predict suitable corrective actions.

The monitoring API 330 may enhance a monitoring service API, by for example specifying for each metric in the database of the metrics it depends on together with its status. A metric measured for a given resource may be related to metrics of resources 110, or for example virtual resources that shares the resource 110, or vice-versa, or to those resources used by the same application it interacts with.

For instance, the “Physical CPU utilization” metric may be related to the “CPU utilization” metrics of VMs (Virtual Machines) sharing the Physical CPU, while the “CPU utilization” metric of a VM may be related to the “bit rate” metric of its Virtual interfaces and/or the “memory utilization” metric etc.

Metric dependencies and the relevant weights and thresholds may be defined on the basis of experts' knowledge, experimental data, and/or through the proposed solution learned by the SLA management node 100 on the basis of computer environment 50 behaviors. Each SLA metric may be defined as a metric with a specific SLA identifier at the monitoring API 330. A status may be updated at the monitoring API 330 each time, for example when SLA metrics, dependent metrics, dependency statuses and/or weights are modified. A specific set of internal alarms may be defined for updating metric status and dependent metrics.

FIG. 9 illustrates some further embodiment of an SLA management node 100. The SLA management node 100 may be comprised by a resource manager 348. A resource manager, such as the resource manger 348, and a cloud manager may have similar meanings or functions. The SLA management node 100 may be operated separately in a computer environment 50. The SLA management node 100 may also be comprised by a host 340. The SLA management node 100 may also be hybrid operated by some functions or unit comprised by the host 340 and some functions or unit comprised by the resource manger 348. The figure also shows an example of a cloud, such the computer cloud 349 shown in the figure. The SLA management node 100 may be suitable for management of resources in a cloud 349.

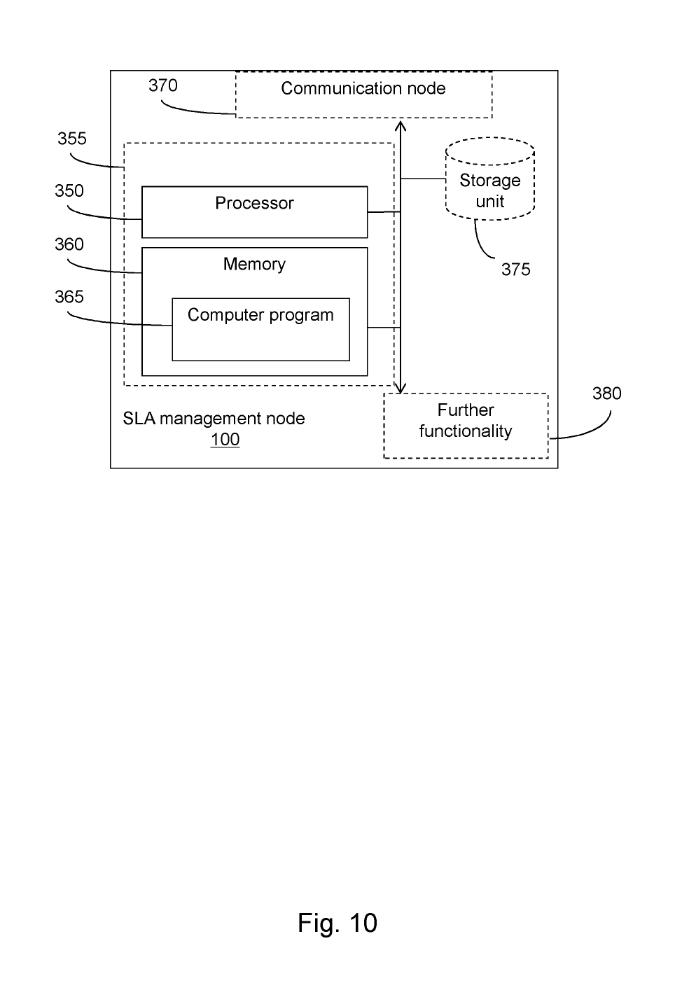

FIG. 10 shows an SLA management node 100 in a computer environment 50 for monitoring and managing of resources 110 for an application 120 comprising processing means, such as the processor 350 and the memory 360, said memory containing instructions executable by said processor whereby said SLA management node 100 is operative for determining an SLA metric for an SLA (Service Level Agreement). The memory 360 further contains instructions executable by said processor whereby the SLA management node 100 is further operative for determining at least one dependent metric for the SLA metric, which indicates a resource 110 performance for the application 120. The memory 360 further contains instructions executable by said processor whereby the SLA management node 100 is further operative for evaluating the at least one dependent metric's influence on the SLA metric. The memory 360 further contains instructions executable by said processor whereby the SLA management node 100 is further operative for determining a weight for the at least one dependent metric, based on the dependent metric influence of the SLA metric, for prediction of the dependent metric influence of the SLA metric.

The SLA management node 100 may further comprise a communication node 370, which may be considered to comprise conventional means for communicating from and/or to the other nodes in the network, such as hosts 340 or other nodes in the computer environment 50. The conventional communication means may include at least one transmitter and at least one receiver. The communication node may further comprise one or more storage units 375 and further functionality 380 useful for the SLA management node 100 to serve its purpose as SLA management node, such as power supply, internal communications bus, internal cooling, database engine, operating system, not limiting to other functionalities.

The instructions executable by said processor may be arranged as a computer program 365 stored in said memory 360. The processor 350 and the memory 360 may be arranged in an arrangement 355. The arrangement 355 may alternatively be a micro processor and adequate software and storage therefore, a Programmable Logic Device, PLD, or other electronic component(s)/processing circuit(s) configured to perform the actions, or methods, mentioned above.

The computer program 365 may comprise computer readable code means, which when run in the SLA management node 100 causes the SLA management node 100 to perform the steps described in any of the methods described in relation to FIG. 2, 3 or 4. The computer program may be carried by a computer program product connectable to the processor. The computer program product may be the memory 360. The memory 360 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 360.

Although the instructions described in the embodiments disclosed above are implemented as a computer program 365 to be executed by the processor 350 at least one of the instructions may in alternative embodiments be implemented at least partly as hardware circuits. Alternatively, the computer program may be stored on a server or any other entity connected to the communication network to which the SLA management node 100 has access via its communication node 370. The computer program may then be downloaded from the server into the memory 360.

While the solution has been described with reference to specific exemplary embodiments, the description is generally only intended to illustrate the inventive concept and should not be taken as limiting the scope of the solution. For example, the terms “SLA management node”, “SLA metric”, “application” and “resource” have been used throughout this description, although any other corresponding nodes, functions, and/or parameters could also be used having the features and characteristics described here. The solution is defined by the appended claims.

1-34. (canceled)

35. A Service Level Agreement (SLA) management node in a computer environment for monitoring and managing resources for an application, comprising:
processing circuitry configured to:
determine an SLA metric for an SLA;
determine at least one dependent metric for the SLA metric, which indicates a resource performance for the application;
evaluate the at least one dependent metric's influence on the SLA metric; and
for each of the at least one dependent metric, determine a weight based on the at least one dependent metric's influence on the SLA metric.

36. The SLA management node according to claim 35, wherein the processing circuitry is configured to:
evaluate a statistical status for the SLA metric, wherein the statistical status is determined as above or below at least one threshold.

37. The SLA management node according to claim 36, wherein the processing circuitry is configured to:
evaluate a dependency status for the SLA metric.

38. The SLA management node according to claim 37, wherein the processing circuitry is configured to:
evaluate the dependency status through a weighted function of the at least one dependent metric's status, wherein the dependency status is determined as above or below at least one threshold.

39. The SLA management node according to claim 37, wherein the processing circuitry is configured to:
compare the statistical status and the dependency status of the SLA metric, wherein when the comparison indicates that the two statuses are different, an updated status of the SLA metric is performed based on a worse value of the statistical status and the dependency status, and wherein the updated status is stored in a data storage.

40. The SLA management node according to claim 37, wherein the processing circuitry is configured to:
when the statistical status and the dependency status are similar, update a current status of the SLA metric, wherein the updated status is stored in a data storage.

41. The SLA management node according to claim 35, wherein the processing circuitry includes or is associated with a corrective action handler, and is configured to:
when a status of the SLA metric or one of the least one dependent metrics is changed, transmit a message to the corrective action handler, the message containing an instruction to change a resource allocation expected to influence the dependent metric.

42. The SLA management node according to claim 35, wherein the processing circuitry is configured to:
when one of the at least one dependent metric, or a resource allocation affecting the dependent metric, is changed, evaluate an impact of the change of the SLA metric in comparison with an expected impact based on a weighted dependent metric, and wherein any deviation between the impact of the change and the expected impact is stored in a knowledge database.

43. The SLA management node according to claim 42, wherein a subsequent instruction to change the resource allocation instructs to adopt the size of the resource allocation based on the previous evaluation of the impact of the SLA metric.
